(19) United States
(12) Patent Application Publication
(10) Pub. No.: US 2006/0165412 A1
(43) Pub. Date: Jul. 27, 2006

(54) Self-healing passive optical network

(75) Inventors: Dae-Kwang Jung, Suwon-si (KR); Chang-Sup Shim, Seoul (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/270,145

(22) Filed: Nov. 9, 2005

(30) Foreign Application Priority Data
Jan. 27, 2005 (KR) 2005-7588

(51) Int. Cl. H04J 14/00

(52) U.S. Cl. 398/71

(57) ABSTRACT

Disclosed is a self-healing passive optical network comprising: a station, such as a central office, for outputting first and second multiplexed downstream optical signals to first and second feeder fibers; a remote node connected to the central office through the first and second feeder fibers to demultiplex each input multiplexed downstream optical signal into a plurality of downstream optical signals and to output the demultiplexed downstream optical signals; and a plurality of optical network units for receiving one or more downstream optical signals, each of the optical network units are connected to the remote node through at least one distribution fiber, wherein the station outputs the first and second multiplexed downstream optical signals to the first and second feeder fibers, respectively, and outputs the first and second multiplexed downstream optical signals to one of the first and second feeder fibers when a defect occurs in a fiber.

### CLAIM OF PRIORITY

This application claims to the benefit of an earlier application entitled “Self-Healing Passive Optical Network,” filed in the Korean Intellectual Property Office on Jan. 27, 2005 and assigned Serial No. 2005-7588, the entire contents of which are incorporated herein by reference.

### BACKGROUND OF THE INVENTION

1. Field of the Invention

The present invention relates to a passive optical network (PON), and more particularly to a passive optical network capable of self-healing defects occurring in an optical fiber.

2. Description of the Related Art

Wavelength division multiplexing passive optical networks (WDM-PONs) provide ultra high-speed broadband communication service using specific wavelengths assigned to each subscriber unit. Consequently, WDM-PONs can ensure the communication security and easily accommodate special communication services or the enlargement of channel capacity required from each subscriber unit. They can also easily increase the number of subscriber units by adding specific wavelengths assigned to such new subscribers. However, in spite of these advantages, the WDM-PON has not yet been used practically. This is because a station, such as a central office (CO) and the like, and each optical network unit (ONU) require both light sources (having specific oscillation wavelengths) and additional wavelength stabilization circuits (for stabilizing the wavelengths of the light sources). These requirements put a heavy economic burden on the subscribers. In order to realize an economic WDM-PON, some conventional WDM-PON have tried using a spectrum-sliced broadband light source, which allows wavelength management to be facilitated, a Fabry-Perot laser diode wavelength-locked with inherent light or a reflective semiconductor optical amplifier, as a WDM light source.

Generally, a WDM-PON uses a double star structure in order to minimize the length of an optical fiber (i.e. the optical line). That is, a central office (CO) and a remote node (RN) installed at an area adjacent to optical network units (ONUs) are connected through one feeder fiber in a PON. This remote node and each optical network unit (ONU) are connected through a separate distribution fiber. In the WDM-PON, a multiplexed downstream optical signal is transmitted to the remote node through the feeder fiber. Then, the multiplexed downstream optical signal is demultiplexed into a plurality of downstream signals by a wavelength division multiplexer located in the remote node. Each of the downstream signals is transmitted to a corresponding optical network unit through a corresponding distribution fiber. Upstream optical signals output from the optical network units are transmitted to the remote node, multiplexed by the wavelength division multiplexer located in the remote node, and then transmitted to the central office.

In the WDM-PON, large amounts of data are transmitted at a high speed based on wavelengths assigned to each optical network unit. Accordingly, when an unexpected abnormality (such as a malfunction or deterioration) of an upstream/downstream light source, or a defect (such as a cut or deterioration) in feeder/distribution fibers occur, the transmitted data may be lost even if the defect occurs only for a short time. Thus, such a defect must be quickly detected and instantly corrected. However, when such a defect occurs, the direct optical line between the central office and the optical network units is cut. Therefore, the central office and the optical network units cannot report the occurrence of the defect to each other. For this situation, a separate low-speed communication line may be provided. However, in order to install the low-speed communication line, additional cost/investment is required for continuously managing and supervising the low-speed communication line. In addition, in order for the central office and each optical network unit to communicate, check a defect occurrence through the separate low-speed communication line, and report the defect occurrence, additional time is required.

Therefore, there is a need in the art to develop a WDM-PON capable of quickly detecting a defect in the feeder fibers or distribution fibers and self-healing the defect. Particularly, in a PON in which each wavelength is shared by a plurality of subscriber units, to reduce the high cost required to realize a typical WDM-PON which allocates a specific wavelength to each subscriber unit.

### SUMMARY OF THE INVENTION

Accordingly, the present invention has been made to reduce or overcome the above-mentioned problems occurring in the prior art. One illustrative object of the present invention is to provide a passive optical network (PON) capable of self-healing a defect in feeder fibers or distribution fibers.

In accordance with one aspect of the present invention, there is provided a self-healing passive optical network comprising: a station, such as a central office, to output first and second multiplexed downstream optical signals to first and second feeder fibers; a remote node connected to the station using the first and second feeder fibers to enable demultiplexing each multiplexed downstream optical signal into a plurality of downstream optical signals and to output the demultiplexed downstream optical signals; and a plurality of optical network units wherein each of the optical network units is connected to the remote node through at least one distribution fiber, wherein the station outputs the first and second multiplexed downstream optical signals to the first and second feeder fibers, respectively, and outputs the first and second multiplexed downstream optical signals to one of the first and second feeder fibers when a defect occurs in a fiber.

### BRIEF DESCRIPTION OF THE DRAWINGS

The present invention will be more apparent from the following detailed description taken in conjunction with the accompanying drawings, in which:

FIG. 1 is a block diagram of a self-healing passive optical network (PON) according to an embodiment of the present invention;

FIG. 2 is a diagram illustrating wavelength bands processed in the self-healing PON shown in FIG. 1;

FIG. 3 is a diagram illustrating the pass band of the Nth wavelength selective coupler of a first optical transceiver array shown in FIG. 1;

FIG. 4 is a diagram illustrating the pass band of a first optical coupler shown in FIG. 1;

FIG. 5 is a block diagram to explain the signal processing procedure when a defect occurs in a first feeder fiber in the PON shown in FIG. 1; and

FIG. 6 is a block diagram to explain the signal processing procedure when a defect occurs in a first working distribution fiber in the PON shown in FIG. 1.

### DETAILED DESCRIPTION

Hereinafter, an embodiment of the present invention will be described with reference to the accompanying drawings. For the purposes of clarity and simplicity, a detailed description of known functions and configurations incorporated herein will be omitted as it may obscure the subject matter of the present invention.

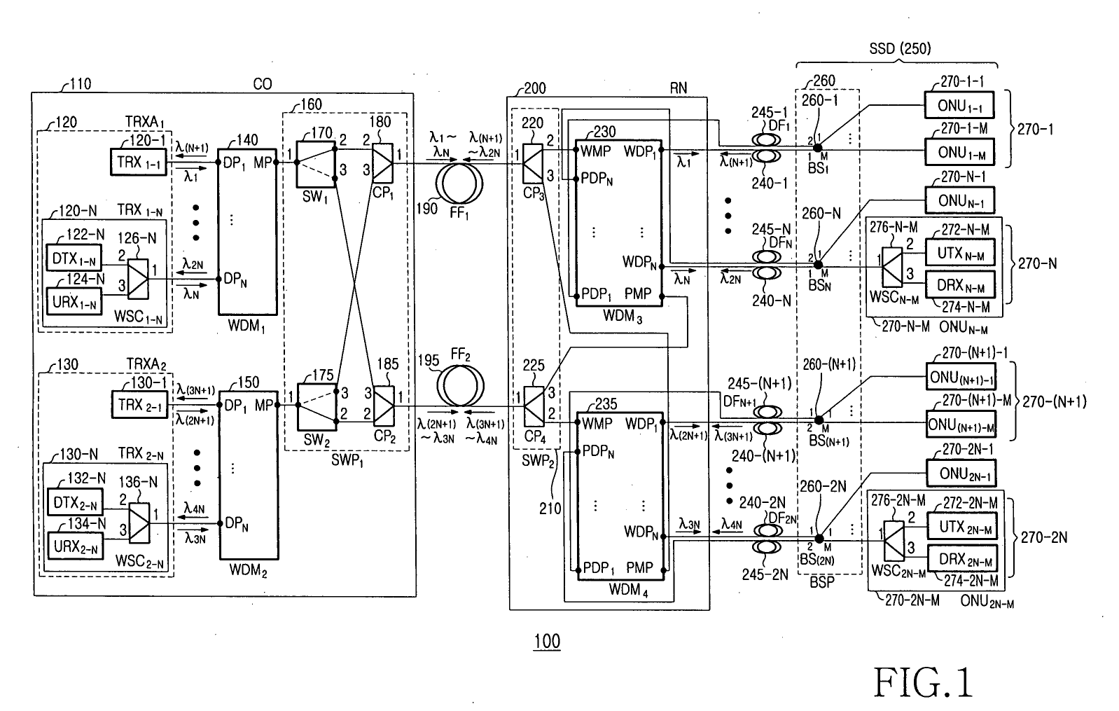

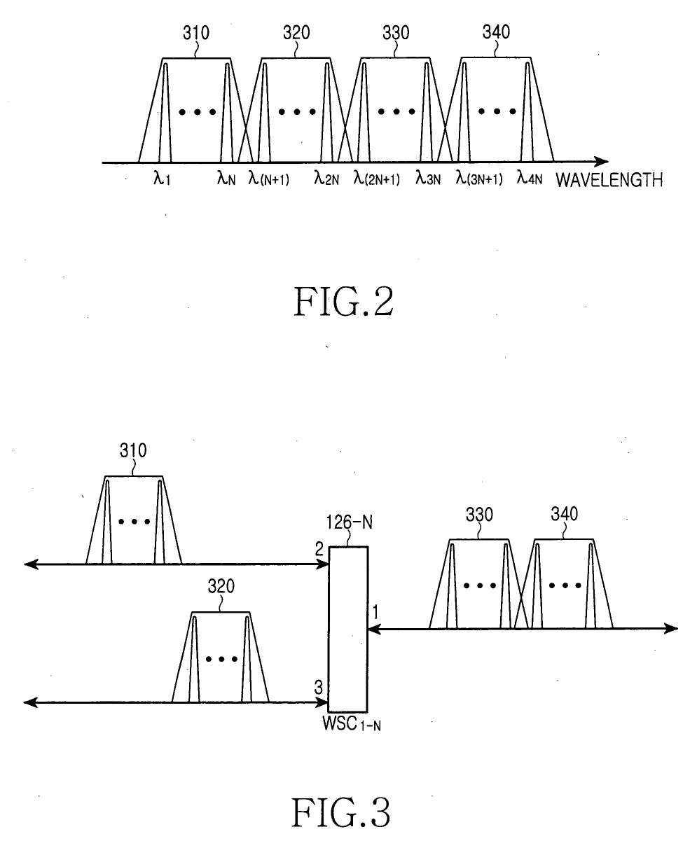

FIG. 1 is a block diagram of a self-healing passive optical network (PON) according to an embodiment of the present invention. FIG. 2 is a diagram illustrating wavelength bands processed in the self-healing PON. The self-healing PON 100 includes a central office (CO) 110, a remote node (RN) 200 connected to the central office 110 through first and second feeder fibers (FF) 190 and 195, and a subscriber-side device (SSD) 250 connected to the remote node 200 through first to 2N^{th} pairs of distribution fibers (DF) 240-1, 245-1, . . . , 240-2N, 245-2N. The subscriber-side device 250 includes a beam splitting part (BSP) 260, and first to 2N^{th} optical network unit groups (ONU groups) 270-1 to 270-2N. The central office 110 transmits first and second multiplexed downstream optical signals and receives first and second multiplexed upstream optical signals. The remote node 200 demultiplexes the received first and second multiplexed downstream optical signals into downstream optical signals of first and second downstream wavelength bands 310 and 330. The remote node 200 then transmits the demultiplexed downstream optical signals to the subscriber-side device 250. Also, the remote node 200 multiplexes received upstream optical signals of first and second upstream wavelength bands 320 and 340 into first and second multiplexed upstream optical signals, and transmits the multiplexed upstream optical signals to the central office 110. Each of ONUs 270-1-1 to 270-2N-M receives a corresponding downstream optical signal from the remote node 200, and transmits a corresponding upstream optical signal to the remote node 200. As shown in FIG. 2, the first and second downstream wavelength bands 310 and 330 and the first and second upstream wavelength bands 320 and 340 are spaced from each other. The first downstream wavelength band 310 includes first to N^{th} wavelengths λ₁ to λ_{N}. The first upstream wavelength band 320 includes (N+1)^{th} to 2N^{th} wavelengths λ_{(N+1)} to λ_{2N}. The second downstream wavelength band 330 includes (2N+1)^{th} to 3N^{th} wavelengths λ_{(2N+1)} to λ_{3N}. The second upstream wavelength band 340 includes (3N+1)^{th} to 4N^{th} wavelengths λ_{(3N+1)} to λ_{4N}.

The central office 110 includes first and second optical transceiver arrays (TRXA) 120 and 130, first and second wavelength division multiplexers (WDM) 140 and 150, and a first switching part (SWP) 160. The first switch part 160 switches the connection between the first and second wavelength division multiplexers 140 and 150 and the first and second feeder fibers 190 and 195, respectively. Each of the first and second optical transceiver arrays 120 and 130 inputs/outputs optical signals of relevant wavelength bands. Each of the first and second wavelength division multiplexers 140 and 150 multiplexes or demultiplexes optical signals of relevant wavelength bands.

The first optical transceiver array 120 includes first to N^{th} optical transceivers (TRX) 120-1 to 120-N, which outputs downstream optical signals of the first downstream wavelength band 310 and receive upstream optical signals of the first upstream wavelength band 320. The first to N^{th} optical transceivers 120-1 to 120-N have the same or similar configuration. The N^{th} optical transceiver 120-N includes an N^{th} downstream optical transmitter (DTX) 122-N (to generate a downstream optical signal of the N^{th} wavelength), an N^{th} upstream optical receiver (URX) 124-N (to photo-electrically convert an upstream optical signal of the 2N^{th} wavelength) and an N^{th} wavelength selective coupler (WSC) 126-N (to output an input upstream optical signal or downstream optical signal to a corresponding output port). The N^{th} wavelength selective coupler 126-N includes first to third ports. Herein, the first port is connected to an N^{th} demultiplexing port (DP) of the first wavelength division multiplexer 140. The second port is connected to the N^{th} downstream optical transmitter 122-N. The third port is connected to the N^{th} upstream optical receiver 124-N. The N^{th} wavelength selective coupler 126-N outputs a downstream optical signal of the N^{th} wavelength that has been input thereto through the second port to the first port. The N^{th} wavelength selective coupler 126-N also outputs an upstream optical signal of the 2N^{th} wavelength that has been input thereto through the first port to the third port. Downstream optical signals of the N^{th} wavelength include first to M^{th} time slots forming one cycle, in which the M^{th} time slot is allocated to the M^{th} ONU 270-N-M of the N^{th} ONU group 270-N. Similarly, upstream optical signals of the 2N^{th} wavelength include first to M^{th} time slots forming one cycle, in which the M^{th} time slot is allocated to the M^{th} ONU 270-N-M of the N^{th} ONU group 270-N.

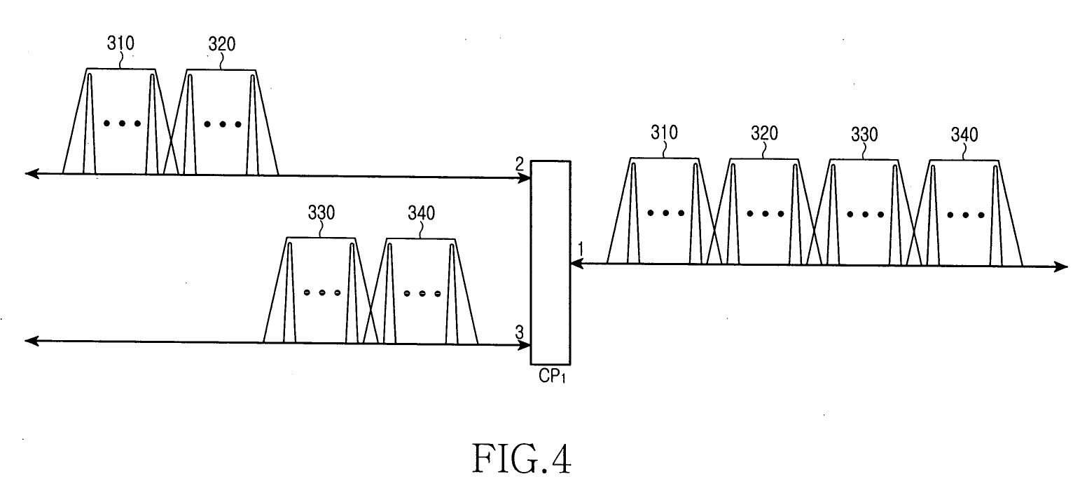

FIG. 3 is a diagram illustrating the pass band of the N^{th} wavelength selective coupler 126-N. As shown in FIG. 3, the N^{th} wavelength selective coupler 126-N separates or combines signals of two different wavelength bands 310 and 320. In particular, the first port allows signals of the first downstream wavelength band 310 and first upstream wavelength band 320 to be input/output. The second port allows signals of the first downstream wavelength band 310 to be input/output. The third port allows signals of the first upstream wavelength band 320 to be input/output.

The first wavelength division multiplexer 140 includes a multiplexing port (MP) connected to a first switch (SW) 170, and first to N^{th} demultiplexing ports connected one-to-one to the first to N^{th} optical transceivers 120-1 to 120-N of the first optical transceiver array 120. The first wavelength division multiplexer 140 multiplexes downstream optical signals of the first downstream wavelength band input from the first to N^{th} demultiplexing ports, into a first multiplexed downstream optical signal. It then outputs the first multiplexed downstream optical signal through the multiplexing port. Also, the first wavelength division multiplexer 140 demultiplexes a first multiplexed upstream optical signal input from the multiplexing port, into upstream optical signals of the first upstream wavelength band. It then outputs the demultiplexed upstream optical signals through the first to N^{th} demultiplexing ports. As shown in FIG. 2, each of the wavelength bands 310 to 340 are identical to the free spectral range (FSR) of the first wavelength division multiplexer 140. This enables the first wavelength division multiplexer 140 to process signals of the first downstream and upstream wavelength bands 310 and 320.

The second optical transceiver array 130 includes first to N^{th} optical transceivers 130-1 to 130-N, which output downstream optical signals of the second downstream wavelength band and receive upstream optical signals of the second upstream wavelength band. The first to N^{th} optical transceivers 130-1 to 130-N have the same or similar configuration. The N^{th} optical transceiver 130-N includes an N^{th} downstream optical transmitter 132-N (to output a downstream optical signal of the 3N^{th} wavelength), an N^{th} upstream optical receiver 134-N (to photo-electrically convert an upstream optical signal of the 4N^{th} wavelength) and an N^{th} wavelength selective coupler 136-N (to output an input upstream optical signal or downstream optical signal to a corresponding output port). The N^{th} wavelength selective coupler 136-N includes first to third ports. The first port is connected to an N^{th} demultiplexing port of the second wavelength division multiplexer 150. The second port is connected to the N^{th} downstream optical transmitter 132-N. The third port is connected to the N^{th} upstream optical receiver 134-N. The N^{th} wavelength selective coupler 136-N outputs a downstream optical signal of the 3N^{th} wavelength input from its second port to its first port. The N^{th} wavelength selective coupler 136-N also outputs an upstream optical signal of the 4N^{th} wavelength input from its first port to its third port. Downstream optical signals of the 3N^{th} wavelength include first to M^{th} time slots forming one cycle, in which the M^{th} time slot is allocated to the M^{th} ONU 270-2N-M of the 2N^{th} ONU group 270-2N. Similarly, upstream optical signals of the 4N^{th} wavelength include first to M^{th} time slots forming one cycle, in which the M^{th} time slot is allocated to the M^{th} ONU 270-2N-M of the 2N^{th} ONU group 270-2N.

The second wavelength division multiplexer 150 includes a multiplexing port connected to a second switch 175, and first to N^{th} demultiplexing ports connected one-to-one to the first to N^{th} optical transceivers 130-1 to 130-N of the second optical transceiver array 130.

The second wavelength division multiplexer 150 multiplexes downstream optical signals of the second downstream wavelength band input from its first to N^{th} demultiplexing ports, into a second multiplexed downstream optical signal. It then outputs the second multiplexed downstream optical signal through its multiplexing port. Also, the second wavelength division multiplexer 150 demultiplexes a second multiplexed upstream optical signal input from its multiplexing port, into upstream optical signals of the second upstream wavelength band. It then outputs the demultiplexed upstream optical signals through its first to N^{th} demultiplexing ports. The second wavelength division multiplexer 150 has a free spectral range identical or similar to that of the first wavelength division multiplexer 140. This enables the second wavelength division multiplexer 150 to process signals of the second downstream and upstream wavelength bands 310 and 320.

The first switching part 160 includes first and second switches 170 and 175 (to switch the transmission paths of first and second multiplexed downstream optical signals) and first and second optical couplers (CP) 180 and 185 (to receive and transfer first and second multiplexed downstream optical signals to the first and second feeder fibers 190 and 195). The first switch 170 includes first to third ports. The first port is connected to the multiplexing port of the first wavelength division multiplexer 140. The second port is connected to a second port of the first optical coupler 180. The third port is connected to a third port of the second optical coupler 185. The first switch 170 selectively connects its first port to either its second or third port.

The second switch 175 includes first to third ports. The first port is connected to the multiplexing port of the second wavelength division multiplexer 150. The second port is connected to a second port of the second optical coupler 185. The third port is connected to a third port of the first optical coupler 180. The second switch 175 selectively connects its first port to either its second or third port.

The first optical coupler 180 includes first to third ports, in which its first port is connected to the first feeder fiber 190. The first optical coupler 180 outputs first and second multiplexed downstream optical signals input through its second and third ports, respectively, to its first port. Also, the first optical coupler 180 outputs a first multiplexed upstream optical signal input through its first port, to its second port. In addition, the first optical coupler 180 outputs a second multiplexed upstream optical signal input through its first port, to its third port.

FIG. 4 is a diagram illustrating the pass band of the first optical coupler. As shown in FIG. 4, the first optical coupler 180 separates or combines signals of four wavelength bands 310 to 340 different from each other. In the first optical coupler 180, its first port allows signals of the first downstream and first upstream wavelength bands 310 and 320 and the second downstream and second upstream wavelength bands 330 and 340 to be input/output. The second port allows signals of the first downstream and first upstream wavelength bands 310 and 320 to be input/output. The third port allows signals of the second downstream and second upstream wavelength bands 330 and 340 to be input/output.

The second optical coupler 185 includes first to third ports, in which its first port is connected to the second feeder fiber 195. The second optical coupler 185 outputs second and first multiplexed downstream optical signals input through its second and third ports, respectively, to its first port. Also, the second optical coupler 185 outputs a second multiplexed upstream optical signal input through its first port, to its second port. In addition, the second optical coupler 185 outputs a first multiplexed upstream optical signal input through its first port, to its third port.

The remote node 200 includes third and fourth wavelength division multiplexers 230 and 235, and a second switching part 210. The second switching part 210 switches optical signal transmission paths between the third and fourth wavelength division multiplexers 230 and 235 and the first and second feeder fibers 190 and 195 depending on wavelengths. Each of the third and fourth wavelength division multiplexers 230 and 235 multiplexes or demultiplexes optical signals of relevant wavelength bands. The second switching part 210 includes third and fourth optical couplers 220 and 225.

The third optical coupler 220 includes first to third ports. The first port is connected to the first feeder fiber 190. The second port is connected to a working multiplexing port (WMP) of the third wavelength division multiplexer 230. The third port is connected to a protection multiplexing port (PMP) of the fourth wavelength division multiplexer 235. The third optical coupler 220 outputs a first multiplexed downstream optical signal input through its first port to its second port. It also outputs a second multiplexed downstream optical signal input through its first port to its third port. Also, the third optical coupler 220 outputs first and second multiplexed upstream optical signals input through its second and third ports, respectively, to its first port.

The fourth optical coupler 225 includes first to third ports. The first port is connected to the second feeder fiber 195. The second port is connected to a working multiplexing port of the fourth wavelength division multiplexer 235. The third port is connected to a protection multiplexing port of the third wavelength division multiplexer 230. The fourth optical coupler 225 outputs a second multiplexed downstream optical signal input through its first port to its second port. It also outputs a first multiplexed downstream optical signal input through its first port to its third port. Also, the fourth optical coupler 225 outputs second and first multiplexed upstream optical signals input through its second and third ports, respectively, to its first port.

The third wavelength division multiplexer 230 includes working and protection multiplexing ports, first to N^{th} working demultiplexing ports (WDP), and first to N^{th} protection demultiplexing ports (PDP). The N^{th} working and protection demultiplexing ports are connected to an N^{th} distribution fiber pair 240-N and 245-N, which includes an N^{th} working distribution fiber 240-N and an N^{th} protection distribution fiber 245-N. The third wavelength division multiplexer 230 demultiplexes a first multiplexed downstream optical signal input through its working multiplexing port into downstream optical signals of the first downstream wavelength band 310. It then outputs the demultiplexed downstream optical signals to its first to N^{th} working demultiplexing ports. The third wavelength division multiplexer 230 demultiplexes a first multiplexed downstream optical signal input through its protection multiplexing port into downstream optical signals of the first downstream wavelength band 310. It then outputs the demultiplexed downstream optical signals to its first to N^{th} protection demultiplexing ports. In addition, the third wavelength division multiplexer 230 multiplexes upstream optical signals of the first upstream wavelength band 320 input through its first to N^{th} working demultiplexing ports into a first multiplexed upstream optical signal. It then outputs the first multiplexed upstream optical signal to its working multiplexing port. The third wavelength division multiplexer 230 multiplexes upstream optical signals of the first upstream wavelength band 320 input through its first to N^{th} protection demultiplexing ports into a first multiplexed upstream optical signal. It then outputs the first multiplexed upstream optical signal to its protection multiplexing port.

The fourth wavelength division multiplexer 235 includes working and protection multiplexing ports, first to N^{th} working demultiplexing ports, and first to N^{th} protection demultiplexing ports. The N^{th} working and protection demultiplexing ports are connected to a 2N^{th} distribution fiber pair 240-2N and 245-2N, which includes a 2N^{th} working distribution fiber 240-2N and a 2N^{th} protection distribution fiber 245-2N. The fourth wavelength division multiplexer 235 demultiplexes a second multiplexed downstream optical signal input through its working multiplexing port into downstream optical signals of the second downstream wavelength band 330. It then outputs the demultiplexed downstream optical signals to its first to N^{th} working demultiplexing ports. The fourth wavelength division multiplexer 235 demultiplexes a second multiplexed downstream optical signal input through its protection multiplexing port into downstream optical signals of the second downstream wavelength band 330. It then outputs the demultiplexed downstream optical signals to its first to N^{th} protection demultiplexing ports. In addition, the fourth wavelength division multiplexer 235 multiplexes upstream optical signals of the second upstream wavelength band 340 input through its first to N^{th} working demultiplexing ports into a second multiplexed upstream optical signal. It then outputs the second multiplexed upstream optical signal to its working multiplexing port. The fourth wavelength division multiplexer 235 multiplexes upstream optical signals of the second upstream wavelength band 340 input through its first to N^{th} protection demultiplexing ports into a second multiplexed upstream optical signal. It then outputs the second multiplexed upstream optical signal to its protection multiplexing port.

The subscriber-side device 250 includes a beam splitting part 260, and first to 2N^{th} ONU groups 270-1 to 270-2N. The beam splitting part 260 includes first to 2N^{th} beam splitters 260-1 to 260-2N, which are connected one-to-one to the first to 2N^{th} distribution fiber pairs 240-1 and 245-1, . . . , 240-2N and 245-2N in regular sequence and have the same configuration.

The N^{th} beam splitter (BS) 260-N is connected to the N^{th} distribution fiber pair 240-N and 245-N. One side of the N^{th} beam splitter 260-N includes first and second coupling ports, and another side of the N^{th} beam splitter 260-N includes first to M^{th} split ports. The first coupling port is connected to the N^{th} working distribution fiber 240-N. The second coupling port is connected to the N^{th} protection distribution fiber 245-N. The first to M^{th} split ports are connected one-to-one to the first to M^{th} ONUs 270-N−1 to 270-N-M of the N^{th} ONU group 270-N in regular sequence. In the N^{th} beam splitter 260-N, the first coupling port is connected to the N^{th} working distribution fiber 240-N. The second coupling port is connected to the N^{th} protection distribution fiber 245-N, and the first to M^{th} split ports are sequentially connected to the first to M^{th} ONUs 270-N−1 to 270-N-M of the N^{th} ONU group 270-N. The Nth beam splitter 260-N power-splits a downstream optical signal of the N^{th} wavelength input through its first or second coupling port into M downstream optical signals. It then outputs the split M downstream optical signals to its first to M^{th} split ports. Also, the N^{th} beam splitter 260-N power-splits upstream optical signals of the 2N^{th} wavelength input through its first to M^{th} split ports into two upstream optical signals. It then outputs the two upstream optical signals to its first and second coupling ports.

The 2N^{th} beam splitter 260-2N is connected to the 2N^{th} distribution fiber pair 240-2N and 245-2N. One side of the 2N^{th} beam splitter 260-2N includes first and second coupling ports, and another side of the 2N^{th} beam splitter 260-2N includes first to M^{th} split ports. The first coupling port is connected to the 2N^{th} working distribution fiber 240-2N. The second coupling port is connected to the 2N^{th} protection distribution fiber 245-2N. The first to M^{th} split ports are connected one-to-one to the first to M^{th} ONUs 270-2N−1 to 270-2N-M of the 2N^{th} ONU group 270-2N in regular sequence. The 2N^{th} beam splitter 260-2N power-splits a downstream optical signal of the 3N^{th} wavelength input through its first or second coupling port into M downstream optical signals. It then outputs the split M downstream optical signals to its first to M^{th} split ports. Also, the 2N^{th} beam splitter 260-2N power-splits upstream optical signals of the 4N^{th} wavelength input through its first to M^{th} split ports into two upstream optical signals. It then outputs the two upstream optical signals to its first and second coupling ports.

The first to 2N^{th} ONU groups 270-1 to 270-2N are connected one-to-one to the first to 2N^{th} beam splitters 260-1 to 260-2N in regular sequence.

The M^{th} ONU 270-N-M of the N^{th} ONU group 270-N includes an M^{th} upstream transmitter (UTX) 272-N-M (to output an upstream optical signal of the 2N^{th} wavelength), an M^{th} downstream receiver (URX) 274-N-M (to photo-electrically convert a downstream optical signal of the N^{th} wavelength), and an M^{th} wavelength selective coupler 276-N-M (to output an input upstream optical signal or downstream optical signal to a corresponding port). The M^{th} wavelength selective coupler 276-N-M includes first to third ports. The first port is connected to the M^{th} split port of the N^{th} beam splitter 260-N. The second port is connected to the M^{th} upstream transmitter 272-N-M. The third port is connected to the M^{th} downstream receiver 274-N-M. The M^{th} wavelength selective coupler 276-N-M outputs an upstream optical signal of the 2N^{th} wavelength input through its second port to its first port. It then outputs a downstream optical signal of the N^{th} wavelength input through its first port to its third port.

The M^{th} ONU 270-2N-M of the 2N^{th} ONU group 270-2N includes an M^{th} upstream transmitter 272-N-M (to output an upstream optical signal of the 4N^{th} wavelength), an M^{th} downstream receiver 274-2N-M (to photo-electrically convert a downstream optical signal of the 3N^{th} wavelength), and an M^{th} wavelength selective coupler 276-2N-M (to output an input upstream optical signal or downstream optical signal to a corresponding port). The M^{th} wavelength selective coupler 276-2N-M includes first to third ports. The first port is connected to the M^{th} split port of the 2N^{th} beam splitter 260-2N. The second port is connected to the M^{th} upstream transmitter 272-2N-M. The third port is connected to the M^{th} downstream receiver 274-2N-M. The M^{th} wavelength selective coupler 276-2N-M outputs an upstream optical signal of the 4N^{th} wavelength input through its second port to its first port. It then outputs a downstream optical signal of the 3N^{th} wavelength input through its first port to its third port.

In a steady state, the following is the procedure for processing downstream optical signals of the first downstream wavelength band 310 in the self-healing PON 100. Each of the first and second switches 170 and 175 connects its first port to its second port.

Downstream optical signals of the first downstream wavelength band 310 output from the first optical transceiver array 120 are multiplexed into a first multiplexed downstream optical signal by the first wavelength division multiplexer 140. Then, the first multiplexed downstream optical signal passes through the first switch 170, the first optical coupler 180, the first feeder fiber 190 and the third optical coupler 220, and are input to the third wavelength division multiplexer 230. The third wavelength division multiplexer 230 demultiplexes the first multiplexed downstream optical signal into downstream optical signals of the first downstream wavelength band 310. The demultiplexed downstream optical signals pass through the first to N^{th} working distribution fibers 240-1 to 240-N, and are input to the first to N^{th} beam splitters 260-1 to 260-N. Each of the first to N^{th} beam splitters 260-1 to 260-N power-splits each downstream optical signal into M downstream optical signals. It then outputs the M downstream optical signals to corresponding first to N^{th} ONU groups 270-1 to 270-N.

In the steady state, the following is the procedure for processing upstream optical signals of the first upstream wavelength band 320 in the self-healing PON 100.

Upstream optical signals of the first upstream wavelength band 320 output from the first to N^{th} ONU groups 270-1 to 270-N are input to the first to N^{th} beam splitters 260-1 to 260-N. Each of the first to N^{th} beam splitters 260-1 to 260-N couple and output upstream optical signals of a corresponding wavelength. Upstream optical signals of the first upstream wavelength band 320 output from the first to N^{th} beam splitters 260-1 to 260-N pass through the first to N^{th} working distribution fibers 240-1 to 240-N, and are input to the third wavelength division multiplexer 230. The third wavelength division multiplexer 230 multiplexes the input upstream optical signals of the first upstream wavelength band 320 into a first multiplexed upstream optical signal and outputs the first multiplexed upstream optical signal. The first multiplexed upstream optical signal passes through the third optical coupler 220, the first feeder fiber 190, the first optical coupler 180 and the first switch 170, and is input to the first wavelength division multiplexer 140. The first wavelength division multiplexer 140 demultiplexes the first multiplexed upstream optical signal into upstream optical signals of the first upstream wavelength band 320. It then outputs the demultiplexed upstream optical signals to the first optical transceiver array 120.

In the steady state, the procedures for processing the second multiplexed downstream optical signal and the second multiplexed upstream optical signal are similar to those described above, so a detailed description thereof will be omitted.

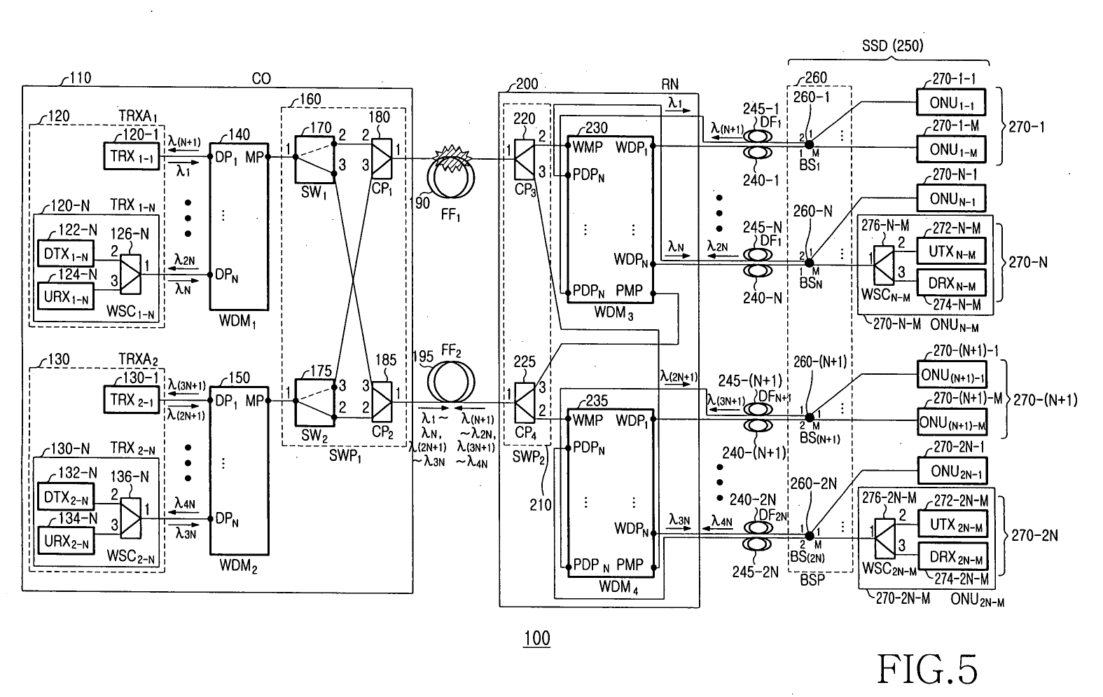

FIG. 5 is a block diagram to explaining the signal processing procedure when a defect occurs in the first feeder fiber 190 in the PON 100 shown in FIG. 1.

When a defect occurs in the first feeder fiber 190, the central office 110 recognizes a defect in the first feeder fiber 190 and controls that the first switch 170 connects its first port to its third port, since the first optical transceiver array 120 cannot receive upstream optical signals of the first upstream wavelength band 320.

In this case, the following is the procedure for processing downstream optical signals of the first downstream wavelength band 310 in the self-healing PON 100.

Downstream optical signals of the first downstream wavelength band 310 output from the first optical transceiver array 120 are multiplexed into a first multiplexed downstream optical signal by the first wavelength division multiplexer 140. The first multiplexed downstream optical signal passes through the first switch 170, the second optical coupler 185, the second feeder fiber 195 and the fourth optical coupler 225, and are input to the third wavelength division multiplexer 230. The third wavelength division multiplexer 230 demultiplexes the first multiplexed downstream optical signal into downstream optical signals of the first downstream wavelength band 310. The demultiplexed downstream optical signals pass through the first to N^{th} protection distribution fibers 245-1 to 245-N, and are input to the first to N^{th} beam splitters 260-1 to 260-N. Each of the first to N^{th} beam splitters 260-1 to 260-N power-splits each input downstream optical signal into M downstream optical signals. It then outputs the M downstream optical signals to a corresponding ONU group selected from among the first to N^{th} ONU groups 270-1 to 270-N.

In addition, in this case, the following is the procedure for processing upstream optical signals of the first upstream wavelength band 320 in the self-healing PON 100.

Upstream optical signals of the first upstream wavelength band 320 from the first to N^{th} ONU groups 270-1 to 270-N are input to the first to N^{th} beam splitters 260-1 to 260-N. Each of the first to N^{th} beam splitters 260-1 to 260-N couple and output upstream optical signals of a corresponding wavelength. Upstream optical signals of the first upstream wavelength band 320 output from the first to N^{th} beam splitters 260-1 to 260-N pass through the first to N^{th} protection distribution fibers 245-1 to 245-N, and are input to the third wavelength division multiplexer 230. The third wavelength division multiplexer 230 multiplexes the input upstream optical signals of the first upstream wavelength band 320 into a first multiplexed upstream optical signal, and outputs the first multiplexed upstream optical signal. The first multiplexed upstream optical signal passes through the fourth optical coupler 225, the second feeder fiber 195, the second optical coupler 185 and the first switch 170, and is input to the first wavelength division multiplexer 140. The first wavelength division multiplexer 140 demultiplexes the first multiplexed upstream optical signal input thereto into upstream optical signals of the first upstream wavelength band 320. It then outputs the demultiplexed upstream optical signals to the first optical transceiver array 120.

In this embodiment, the procedures for processing the second multiplexed downstream optical signal and the second multiplexed upstream optical signal are similar to those described above, so a detailed description thereof will be omitted to avoid redundancy.

In addition, when a defect occurs in the second feeder fiber 195, procedures similar to those described above may be performed, so a detailed description thereof will be omitted.

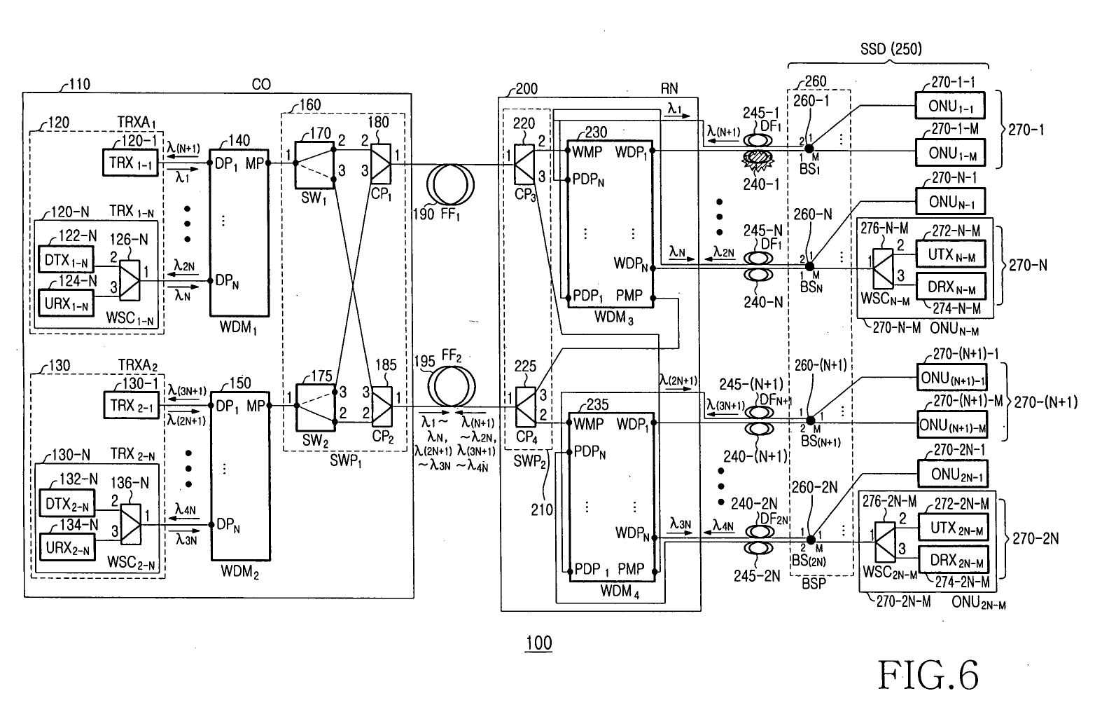

FIG. 6 is a block diagram to explain the signal processing procedure when a defect occurs in the first working distribution fiber 240-1 in the PON 100 shown in FIG. 1.

In the case in which a defect occurs in the first working distribution fiber 240-1, the central office 110 recognizes a defect in the first working distribution fiber 240-1 and controls that the first switch 170 connects its first port to its third port, since the first optical transceiver array 120 cannot receive an upstream optical signal of the (N+1)^{th} wavelength.

In this case, the following is the procedure for processing downstream optical signals of the first downstream wavelength band 310 in the self-healing PON 100.

Downstream optical signals of the first downstream wavelength band 310 output from the first optical transceiver array 120 are multiplexed into a first multiplexed downstream optical signal by the first wavelength division multiplexer 140. The first multiplexed downstream optical signal passes through the first switch 170, the second optical coupler 185, the second feeder fiber 195 and the fourth optical coupler 225, and are input to the third wavelength division multiplexer 230. The third wavelength division multiplexer 230 demultiplexes the first multiplexed downstream optical signal into downstream optical signals of the first downstream wavelength band 310. The demultiplexed downstream optical signals pass through the first to N^{th} protection distribution fibers 245-1 to 245-N, and are input to the first to N^{th} beam splitters 260-1 to 260-N. Each of the first to N^{th} beam splitters 260-1 to 260-N power-splits each input downstream optical signal into M downstream optical signals. It then outputs the M downstream optical signals to a corresponding ONU group selected from among the first to N^{th} ONU groups 270-1 to 270-N.

In addition, in this case, the following is the procedure for processing upstream optical signals of the first upstream wavelength band 320 in the self-healing PON 100.

Upstream optical signals of the first upstream wavelength band 320 output from the first to N^{th} ONU groups 270-1 to 270-N are input to the first to N^{th} beam splitters 260-1 to 260-N. Each of the first to N^{th} beam splitters 260-1 to 260-N couple and output upstream optical signals of a corresponding wavelength. Upstream optical signals of the first upstream wavelength band 320 output from the first to N^{th} beam splitters 260-1 to 260-N pass through the first to N^{th} protection distribution fibers 245-1 to 245-N, and are input to the third wavelength division multiplexer 230. The third wavelength division multiplexer 230 multiplexes the input upstream optical signals of the first upstream wavelength band 320 into a first multiplexed upstream optical signal, and outputs the first multiplexed upstream optical signal. The first multiplexed upstream optical signal passes through the fourth optical coupler 225, the second feeder fiber 195, the second optical coupler 185 and the first switch 170, and is input to the first wavelength division multiplexer 140. The first wavelength division multiplexer 140 demultiplexes the first multiplexed upstream optical signal input thereto into upstream optical signals of the first upstream wavelength band 320. It then outputs the demultiplexed upstream optical signals to the first optical transceiver array 120.

In this embodiment, the procedures for processing the second multiplexed downstream optical signal and the second multiplexed upstream optical signal are similar to those described above, so a detailed description thereof will be omitted.

As described above, according to the embodiment of the present invention, the self-healing PON outputs the first and second multiplexed downstream optical signals through either the first or second feeder fiber by using the first and second switching parts when a defect occurs in an optical fiber. Thus, the defect in the feeder fibers or distribution fibers can be self-healed.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A self-healing passive optical network comprising:
a station to output first and second multiplexed downstream optical signals to first and second feeder fibers;
a remote node connected to the station using the first and second feeder fibers to enable demultiplexing each multiplexed downstream optical signal into a plurality of downstream optical signals; and
a plurality of optical network units, wherein each optical network unit is connected to the remote node through at least one distribution fiber, and wherein the station outputs the first and second multiplexed downstream optical signals to the first and second feeder fibers, respectively and outputs the first and second multiplexed downstream optical signals to one of the first and second feeder fibers when a defect occurs in a fiber.

2. The self-healing passive optical network as claimed in claim 1, wherein the station is a central office.

3. The self-healing passive optical network as claimed in claim 2, wherein the central office comprises:
a first switch to receive the first multiplexed downstream optical signal, the first switch is selectively connected to one of the first and second feeder fibers; and
a second switch to receive the second multiplexed downstream optical signal, the first switch is selectively connected to one of the first and second feeder fibers,
wherein the first and second switches are connected one-to-one to the first and second feeder fibers, and the first and second switches are connected commonly to one of the first and second feeder fibers when a defect occurs in a fiber.

4. The self-healing passive optical network as claimed in claim 3, wherein the central office comprises:
a first optical coupler to output first and second multiplexed downstream optical signals from the first and second switches to the first feeder fiber; and
a second optical coupler to output first and second multiplexed downstream optical signals from the first and second switches to the second feeder fiber.

5. The self-healing passive optical network as claimed in claim 2, wherein the central office comprises:
a first optical transceiver array to output downstream optical signal of a first downstream wavelength band;
a second optical transceiver array to output downstream optical signal of a second downstream wavelength band;
a first wavelength division multiplexer to multiplex the downstream optical signal of the first downstream wavelength band into a first multiplexed downstream optical signal; and
a second wavelength division multiplexer to multiplex the downstream optical signal of the second downstream wavelength band into a second multiplexed downstream optical signal.

6. The self-healing passive optical network as claimed in claim 5, wherein the first wavelength division multiplexers output the respective second multiplexing downstream optical signals.

7. The self-healing passive optical network as claimed in claim 5, wherein each of the first and second optical transceiver arrays includes a plurality of optical transceivers,
each of the optical transceivers comprises:
a downstream optical transmitter to output a downstream optical signal;
an upstream optical receiver to photo-electrically convert an upstream optical signal; and
a wavelength selective coupler to output the upstream optical signal from a corresponding wavelength division multiplexer to the upstream optical receiver, and output the downstream optical signal from the downstream optical transmitter to the corresponding wavelength division multiplexer.

8. The self-healing passive optical network as claimed in claim 1, wherein the remote node comprises:
a third wavelength division multiplexer to demultiplex a first multiplexed downstream optical signal into downstream optical signals of a first downstream wavelength band; and
a fourth wavelength division multiplexer to demultiplex a second multiplexed downstream optical signal into downstream optical signals of a second downstream wavelength band, and outputting the demultiplexed downstream optical signals of the second downstream wavelength band.

9. The self-healing passive optical network as claimed in claim 8, wherein the demultiplexed downstream optical signals of the first and second downstream wavelength bands are respectively output by the third and fourth wavelength division multiplexers.

10. The self-healing passive optical network as claimed in claim 8, wherein the remote node further comprises:
a third optical coupler connected to the first feeder fiber to output a first multiplexed downstream optical signal to the third wavelength division multiplexer, and output a second multiplexed downstream optical signal to the fourth wavelength division multiplexer; and
a fourth optical coupler connected to the second feeder fiber to output a first multiplexed downstream optical signal to the third wavelength division multiplexer, and output a second multiplexed downstream optical signal to the fourth wavelength division multiplexer.
